(19) United States
(12) Patent Application Publication
(10) Pub. No.: US 2025/0210738 A1
(43) Pub. Date: Jun. 26, 2025

(54) BATTERY PACK DETECTION SYSTEM AND DETECTION METHOD FOR BATTERY PACK MODULE

(71) Applicant: INDUSTRIAL TECHNOLOGY RESEARCH INSTITUTE, Hsinchu (TW)

(72) Inventors: Hua-Lun CHI, Taichung City (TW); Che-Kai YEH, Tainan City (TW); Chien-Nan YEH, Tainan City (TW); Chao-Ta HUANG, Hsinchu City (TW)

(73) Assignee: INDUSTRIAL TECHNOLOGY RESEARCH INSTITUTE, Hsinchu (TW)

(21) Appl. No.: 18/974,566

(22) Filed: Dec. 9, 2024

(30) Foreign Application Priority Data
Dec. 25, 2023 (TW) 112150493

(51) Int. Cl. H01M 10/42

(52) U.S. Cl. CPC H01M 10/4285; H01M 10/4207; H01M 2200/20

(57) ABSTRACT

A battery pack detection system configured to be arranged surrounding a battery pack formed by a plurality of batteries arranged in an M×N array includes first sensing modules, second sensing modules and a computing module. Each first sensing module includes M first sensing parts each configured to sense a sum of first expansions of the N batteries in the corresponding column. Each second sensing module includes N second sensing parts each configured to sense a sum of second expansions of the M batteries in the corresponding row. Each of M and N is an integer greater than or equal to 2. The computing module connects with the first sensing modules and the second sensing modules so as to determine whether each battery is a defective battery based on the first expansion sum, the second expansion sum, corresponding first addresses and corresponding second addresses.

### CROSS-REFERENCE TO RELATED APPLICATIONS

This non-provisional application claims priority under 35 U.S.C. § 119(a) on Patent Application No(s). 112150493 filed in Taiwan, R.O.C. on Dec. 25, 2023, the entire contents of which are hereby incorporated by reference.

### Technical Field

The present disclosure relates to a battery detection system and a battery detection method, more particularly to a detection system and a detection method for batteries arranged in an array.

### Background

With the development of electric vehicles and energy storage systems, arranging multiple batteries into a battery pack to obtain a greater power source has become a popular trend in the related field.

A degraded and expanded battery will reduce its power output, thereby affecting the overall power output of a battery pack where the degraded and expanded battery is located. Therefore, the excessively expanded battery needs to be timely replaced to ensure a stable power output. The conventional method is to set up detection units on batteries one by one, so that the expansion of each battery can be timely detected. However, as the quantity of batteries of a battery pack increases, the more detection units are needed. This will significantly increase the cost required to detect the battery pack, and will occupy the space between batteries to result in poor space utilization.

### SUMMARY

The present disclosure provides a battery pack detection system and a detection method for a battery pack module capable of accurately finding an excessively expanded battery among a battery pack by using cheap and simple components for detecting the battery pack.

According to one aspect of the present disclosure, a battery pack detection system configured to be arranged surrounding a battery pack includes two first sensing modules, two second sensing modules and a computing module. The battery pack includes a plurality of batteries arranged in an array, wherein a quantity of the plurality of batteries is M×N, and the battery pack has a quantity of M of the plurality of batteries that are arranged on a first side and a quantity of N of the plurality of batteries that are arranged on a second side adjacent to the first side. The two first sensing modules are respectively disposed on the first side and another first side of the battery pack, wherein the first side and the another first side are located on opposite sides of the battery pack, and each of the two first sensing modules includes M first sensing parts configured to sense a sum of first expansions of corresponding batteries among the plurality of batteries and to output M first deformations. The two second sensing modules are respectively disposed on the second side and another second side of the battery pack, wherein the second side and the another second side are located on opposite sides of the battery pack, and each of the two second sensing modules includes N second sensing parts configured to sense a sum of second expansions of corresponding batteries among the plurality of batteries and to output N second deformations. Each of M and N is an integer greater than or equal to 2. The computing module connects with the two first sensing modules and the two second sensing modules to receive the M first deformations of at least one of the two first sensing modules and the N second deformations of at least one of the two second sensing modules so as to obtain M first addresses corresponding to the M first deformations and N second addresses corresponding to the N second deformations to accordingly determine whether each of the plurality of batteries is a defective battery. When a first expansion of one of the plurality of batteries exceeds a first expansion threshold and a second expansion of the one of the plurality of batteries exceeds a second expansion threshold, the computing module defines the one of the plurality of batteries as the defective battery.

According to another aspect of the present disclosure, a detection method for a battery pack module suitable for a battery pack includes a deformation-acquisition process and a determination process. The battery pack includes a plurality of batteries arranged in an array, wherein a quantity of the plurality of batteries is M×N, and the battery pack has a quantity of M of the plurality of batteries that are arranged on a first side and a quantity of N of the plurality of batteries that are arranged on a second side adjacent to the first side. Each of M and N is an integer greater than or equal to 2. The deformation-acquisition process includes the following steps: sensing a sum of first expansions of corresponding batteries among the plurality of batteries by M first sensing parts of each of two first sensing modules respectively disposed on the first side and the another side of the battery pack to output M first deformations, wherein the first side and the another first side are located on opposite sides of the battery pack; and sensing a sum of second expansions of corresponding batteries among the plurality of batteries by N second sensing parts of each of two sensing modules respectively disposed on the second side and the another side of the battery pack to output N second deformations, wherein the second side and the another second side are located on opposite sides of the battery pack. The determination process includes the following step: determining whether each of the plurality of batteries is a defective battery according to the M first deformations output by each of the two first sensing modules, M first addresses corresponding to the M first deformations, the N second deformations output by each of the two second sensing modules and N second addresses corresponding to the N second deformations, wherein one of the plurality of batteries is defined as the defective battery when a first expansion of the one of the plurality of batteries is determined as exceeding a first expansion threshold and a second expansion of the one of the plurality of batteries is determined as exceeding a second expansion threshold.

According to the battery pack detection system and the detection method for the battery pack module discussed above, only disposing the first sensing modules and the second sensing modules at the periphery of the battery pack, by utilizing the calculation and determination of the computing module, at least one excessively expanded battery among the plurality of batteries of the battery pack can be accurately found. Accordingly, the components used in the overall battery pack detection system are cheap and simple, which can reduce the cost of detecting the battery pack and improve the space utilization between batteries of the battery pack.

### BRIEF DESCRIPTION OF THE DRAWINGS

The present disclosure will become more fully understood from the detailed description given hereinbelow and the accompanying drawings which are given by way of illustration only and thus are not intending to limit the present disclosure and wherein:

FIG. 1 is a block diagram of a battery pack detection system according to one embodiment of the present disclosure;

FIG. 2 is a perspective view of the battery pack detection system in FIG. 1 combined with a battery pack where a computing module is removed;

FIG. 3 is a perspective view of the battery pack detection system in FIG. 2 where the computing module is removed and first protectors and a second protector are exploded;

FIG. 4 is a top view of the battery pack detection system in FIG. 2 combined with the battery pack where the computing module is removed;

FIG. 5 is a front view of the battery pack detection system in FIG. 2 combined with the battery pack where the computing module is removed;

FIG. 6 is a front view of the battery pack detection system in FIG. 2 combined with the battery pack where the computing module and the first protectors are removed;

FIG. 7 is a side view of the battery pack detection system in FIG. 2 combined with the battery pack where the computing module is removed;

FIG. 8 is a side view of the battery pack detection system in FIG. 2 combined with the battery pack where the computing module and the second protector are removed;

FIG. 9 is a circuit diagram of Wheatstone bridges and the computing module of the battery pack detection system according to one embodiment of the present disclosure;

FIG. 10 is a top view of a battery pack detection system according to another embodiment of the present disclosure combined with a battery pack where a computing module is removed;

FIG. 11 to FIG. 14 are flow charts of a detection method for the battery pack module according to further another embodiment of the present disclosure;

FIG. 15 is a schematic view showing data stored in a storage unit that is used in a detection method for the battery pack module according to further another embodiment of the present disclosure;

FIG. 16 is a schematic and top view of a battery pack detection system according to further another embodiment of the present disclosure combined with a battery pack where a computing module is removed;

FIG. 17 is a schematic view showing data stored in a storage unit that is used in a detection method for the battery pack module according to still further another embodiment of the present disclosure; and

FIG. 18 is a schematic and top view of a battery pack detection system according to still further another embodiment of the present disclosure combined with a battery pack where a computing module is removed.

### DETAILED DESCRIPTION

Aspects and advantages of the invention will become apparent from the following detailed descriptions with the accompanying drawings. For purposes of explanation, one or more specific embodiments are given to provide a thorough understanding of the invention, and which are described in sufficient detail to enable one skilled in the art to practice the described embodiments. It should be understood that the following descriptions are not intended to limit the embodiments to one specific embodiment. On the contrary, it is intended to cover alternatives, modifications, and equivalents as can be included within the spirit and scope of the described embodiments as defined by the appended claims.

Firstly, in the present disclosure, each of M and N is defined as an integer greater than or equal to 2.

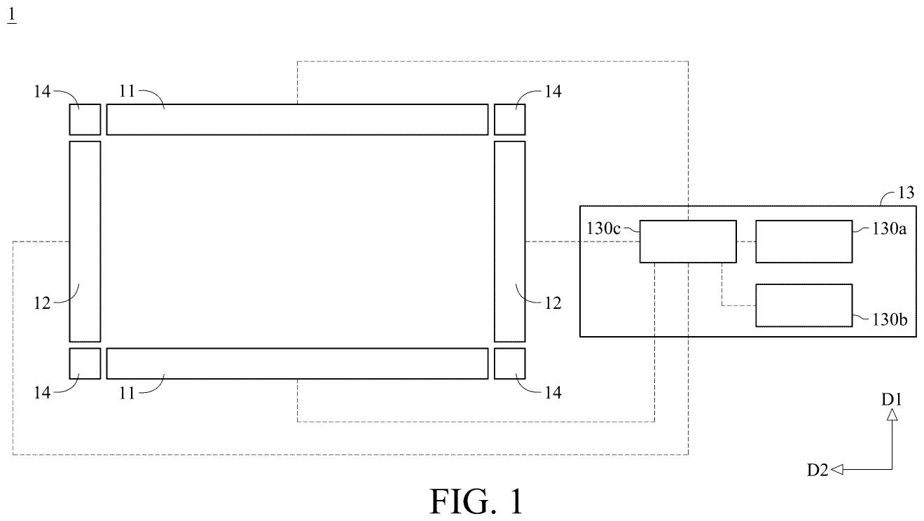

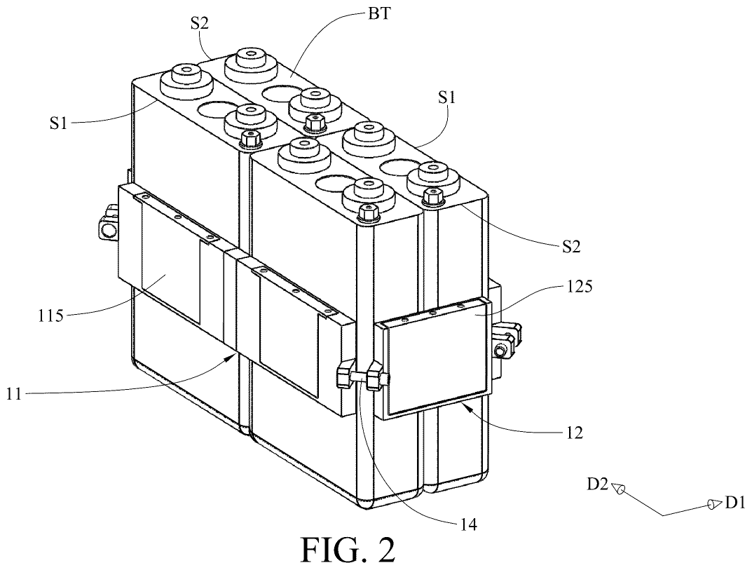

Please refer to FIG. 1 and FIG. 2, where FIG. 1 is a block diagram of a battery pack detection system according to one embodiment of the present disclosure, and FIG. 2 is a perspective view of the battery pack detection system in FIG. 1 combined with a battery pack where a computing module is removed. Please be noted that some parts (e.g., a computing module 13 in the following description) in FIG. 2 are removed for simplicity.

A battery pack detection system 1 provided in this embodiment is configured to be arranged surrounding a battery pack (not numbered, and it may also be considered as a battery pack module). The battery pack includes a plurality of batteries arranged in an array. The quantity of the plurality of batteries is M×N. The battery pack has the quantity of M of the plurality of batteries arranged on a first side and the quantity of N of the plurality of batteries arranged on a second side adjacent to the first side. For example, as shown in FIG. 2, the battery pack includes four batteries BT arranged in a 2×2 array, wherein the battery pack has two batteries BT arranged on the first side S1 and two batteries BT arranged on the second side S2.

The battery pack detection system in this embodiment may include two first sensing modules 11, two second sensing modules 12, the computing module 13 and a plurality of connectors 14.

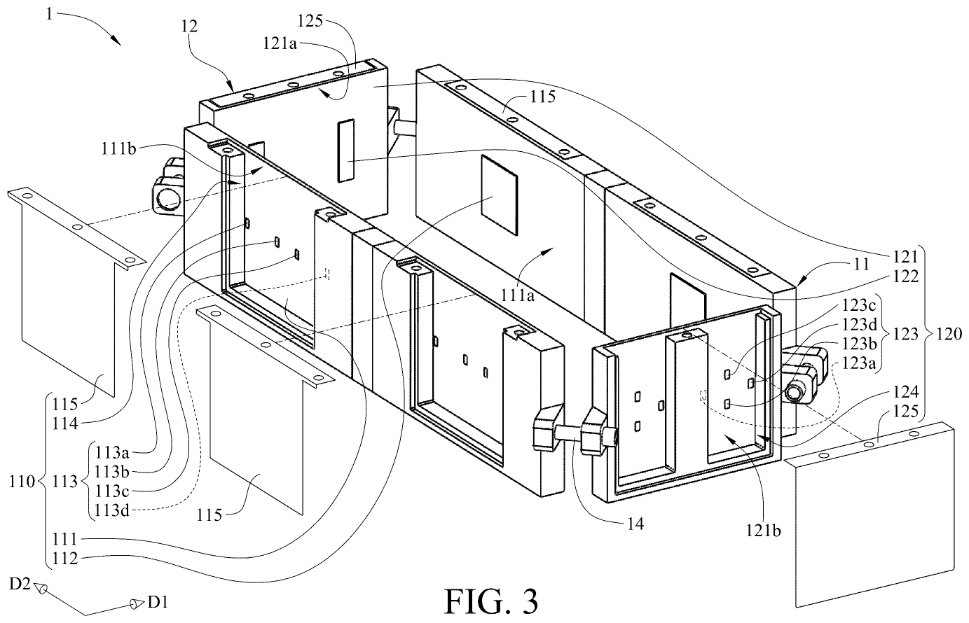

Please further refer to FIG. 3 together with FIG. 1 and FIG. 2, where FIG. 3 is a perspective view of the battery pack detection system in FIG. 2 where the computing module is removed and first protectors and a second protector are exploded. Please be noted that some parts (e.g., the computing module 13) in FIG. 3 are removed for simplicity.

The first sensing modules 11 are respectively disposed on two opposite first sides S1 (they can also be considered as one first side and another first side) of the battery pack. Each first sensing module 11 includes M first sensing parts 110. In this embodiment, M is, for example, 2, but the present disclosure is not limited thereto.

The second sensing modules 12 are respectively disposed on two opposite second sides S2 (they can also be considered as one second side and another second side) of the battery pack. Each second sensing module 12 includes N second sensing parts 120. In this embodiment, N is, for example, 2, but the present disclosure is not limited thereto.

The computing module 13 may include a storage unit 130a, a determination unit 130b and a calculation unit 130c. The storage unit 130a stores a first safety threshold and a second safety threshold therein, wherein each of the first safety threshold and the second threshold may be different values depending on different types of batteries BT. The calculation unit 130c connects with the storage unit 130a and the determination unit 130b. Please be noted that the storage unit 130a, the determination unit 130b and the calculation unit 130c are not intended to restrict the present disclosure. In some embodiments of the present disclosure, the computing module may include one, two, four or more electrical units having storage, determination and calculation functions.

Each connector 14 connects one first sensing module 11 and one second sensing module 12 that are adjacent to each other and are detachable from each other.

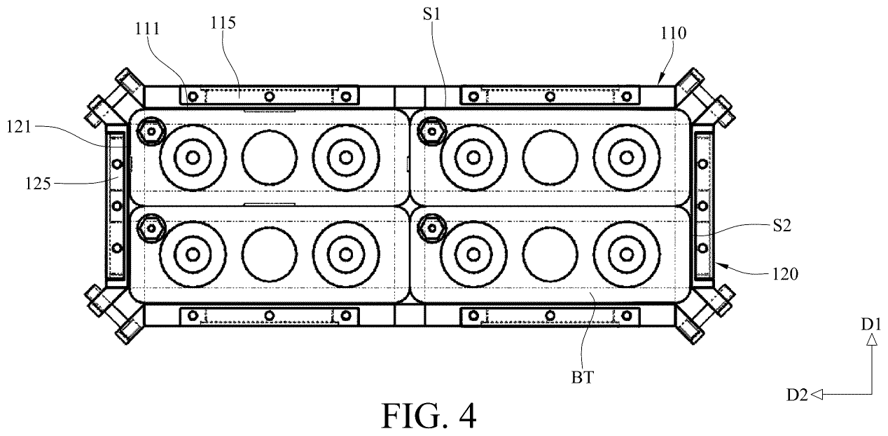

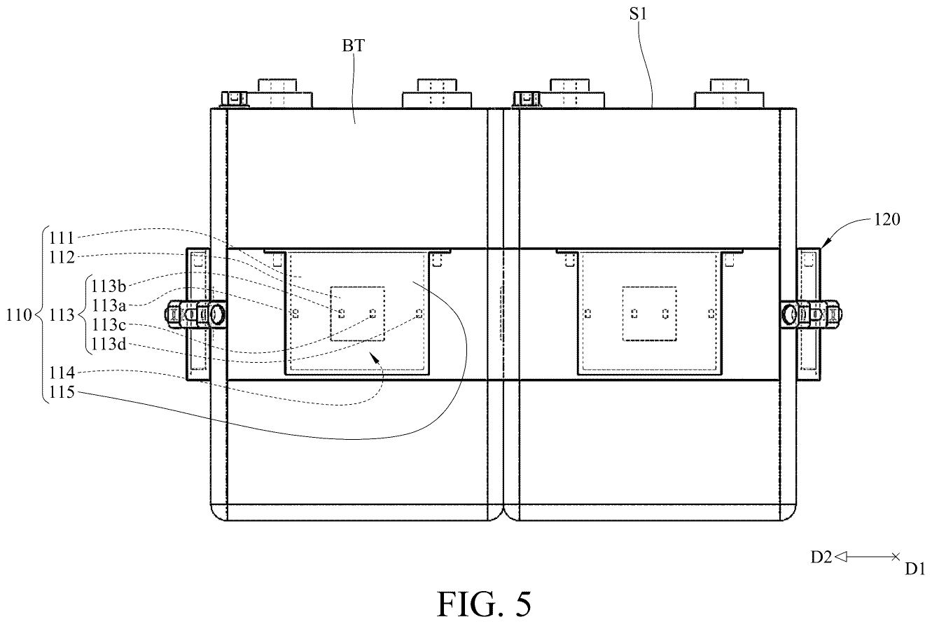

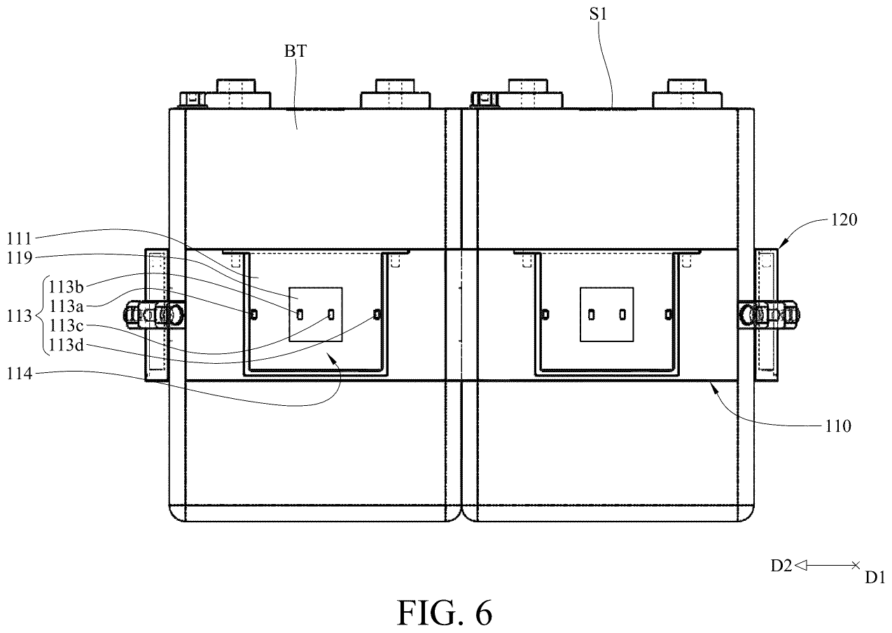

Please further refer to FIG. 4 to FIG. 6 together with FIG. 2 and FIG. 3 to further clearly understanding the structure of the first sensing modules 11, where FIG. 4 is a top view of the battery pack detection system in FIG. 2 combined with the battery pack where the computing module is removed, FIG. 5 is a front view of the battery pack detection system in FIG. 2 combined with the battery pack where the computing module is removed, and FIG. 6 is a front view of the battery pack detection system in FIG. 2 combined with the battery pack where the computing module and the first protectors are removed. Please be noted that some parts (e.g., the computing module 13 and part of first protectors 115 in the following description) in FIG. 4 to FIG. 6 are removed for simplicity.

Each first sensing part 110 may include a first wall 111, a first protrusion 112, a first sensing group 113 and a first recess 114.

Among each first sensing part 110, the first wall 111 may have a first surface 111a facing towards the batteries BT and a second surface 111b facing away from the batteries BT. The first protrusion 112 may be disposed on the first surface 111a of the first wall 111. The first sensing group 113 may be disposed on the second surface 111b of the first wall 111.

Each first sensing group 113 may include, for example, four first sensing elements 113a, 113b, 113c, 113d. Each of the first sensing elements 113a, 113b, 113c, 113d may be, for example, a strain gauge, but the present disclosure is not limited thereto. Among each first sensing part 110, a projection of the first protrusion 112 onto the second surface 111b of the first wall 111 is defined as a first projection range 119. As shown in FIG. 6, among each first sensing part 110, two first sensing elements 113b, 113c are located within the first projection range 119, and another two first sensing elements 113a, 113d are located outside of the first projection range 119. Please be noted that the quantity and the arrangement of the first sensing elements 113a, 113b, 113c, 113d are not intended to restrict the present disclosure.

As shown in FIG. 3 and FIG. 6, among each first sensing part 110, the first recess 114 exposes the second surface 111b of the first wall 111, and the first sensing elements 113a, 113b, 113c, 113d are located in the first recess 114.

As shown in FIG. 2 to FIG. 5, each first sensing module 11 may further include two first protectors 115. The first protectors 115 respectively cover the first recesses 114 corresponding thereto. There is a room (not numbered) located between the first protectors 115 and the first sensing elements 113a, 113b, 113c, 113d, and the first protectors 115 isolate the first sensing elements 113a, 113b, 113c, 113d from external environment, such that the first sensing elements 113a, 113b, 113c, 113d can be prevented from the interferences generated by environmental factors such as temperature, humidity and vibration, thereby ensuring sensing accuracy, precision and reliability of the first sensing elements 113a, 113b, 113c, 113d.

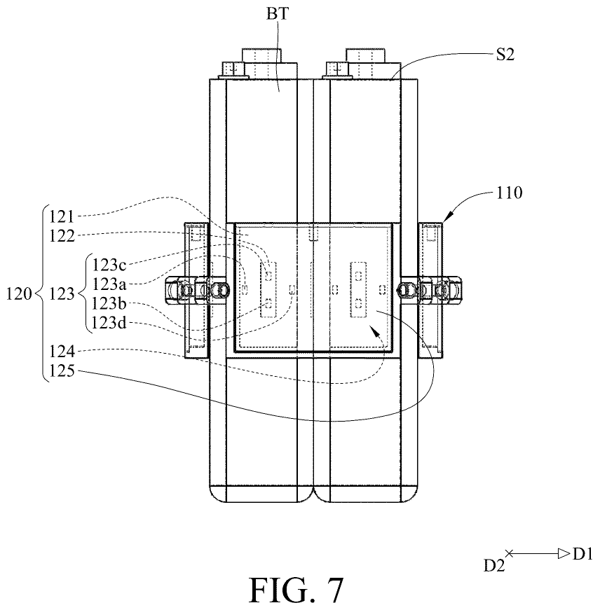

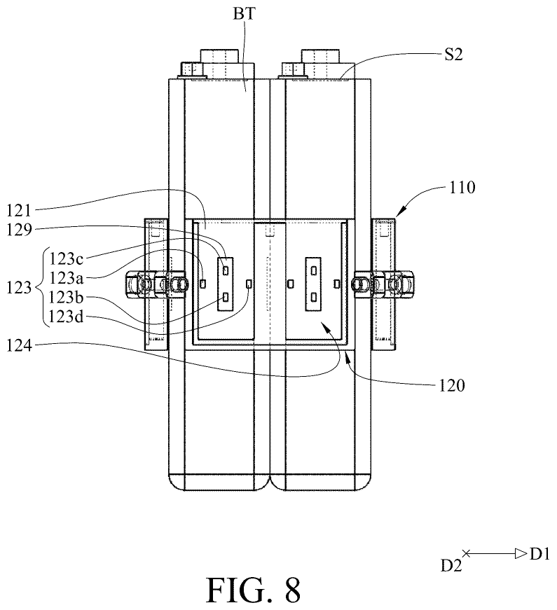

Please further refer to FIG. 7 to FIG. 8 together with FIG. 2 to FIG. 4 to further clearly understanding the structure of the second sensing modules 12, where FIG. 7 is a side view of the battery pack detection system in FIG. 2 combined with the battery pack where the computing module is removed, FIG. 8 is a side view of the battery pack detection system in FIG. 2 combined with the battery pack where the computing module and the second protector are removed. Please be noted that some parts (e.g., the computing module 13 and part of second protectors 125 in the following description) in FIG. 7 to FIG. 8 are removed for simplicity.

Each second sensing part 120 may include a second wall 121, a second protrusion 122, a second sensing group 123 and a second recess 124.

Among each second sensing part 120, the second wall 121 may have a first surface 121a facing towards the batteries BT and a second surface 121b facing away from the batteries BT. The second protrusion 122 may be disposed on the first surface 121a of the second wall 121. The second sensing group 123 may be disposed on the second surface 121b of the second wall 121.

Each second sensing group 123 may include, for example, four second sensing elements 123a, 123b, 123c, 123d. Each of the second sensing elements 123a, 123b, 123c, 123d may be, for example, a strain gauge, but the present disclosure is not limited thereto. Among each second sensing part 120, a projection of the second protrusion 122 onto the second surface 121b of the second wall 121 is defined as a second projection range 129. As shown in FIG. 8, among each second sensing part 120, two second sensing elements 123b, 123c are located within the second projection range 129, and another two second sensing elements 123a, 123d are located outside of the second projection range 129. Please be noted that the quantity and the arrangement of the second sensing elements 123a, 123b, 123c, 123d are not intended to restrict the present disclosure.

As shown in FIG. 3 and FIG. 8, among each second sensing part 120, the second recess 124 exposes the second surface 121b of the second wall 121, and the second sensing elements 123a, 123b, 123c, 123d are located in the second recess 124.

As shown in FIG. 2 to FIG. 4 and FIG. 7, each second sensing module 12 may further include a second protector 125. The second protector 125 covers the two second recesses 124 corresponding thereto. There is a room (not numbered) located between the second protector 125 and the second sensing elements 123a, 123b, 123c, 123d, and the second protector 125 isolates the second sensing elements 123a, 123b, 123c, 123d from external environment, such that the second sensing elements 123a, 123b, 123c, 123d can be prevented from the interferences generated by environmental factors such as temperature, humidity and vibration, thereby ensuring sensing accuracy, precision and reliability of the second sensing elements 123a, 123b, 123c, 123d.

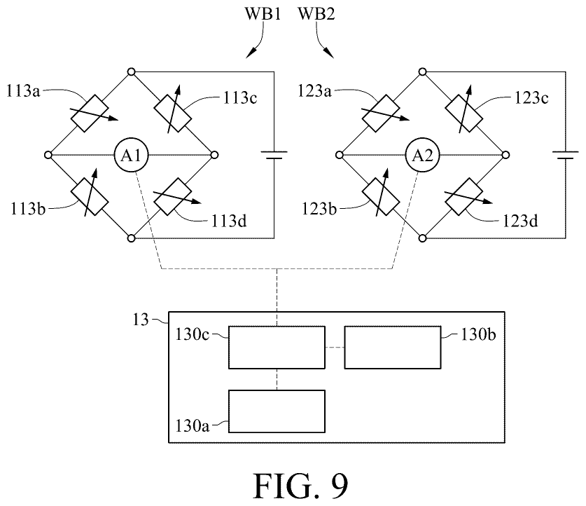

Please further refer to FIG. 9 together with FIG. 1 to FIG. 8, where FIG. 9 is a circuit diagram of Wheatstone bridges and the computing module of the battery pack detection system according to one embodiment of the present disclosure. Please be noted that different stresses may be applied on the first sensing elements 113a, 113b, 113c, 113d (e.g., strain gauges) and the second sensing elements 123a, 123b, 123c, 123d (e.g., strain gauges) to generate different strains thereon, such that the electrical resistance of the first and second sensing elements 113a, 113b, 113c, 113d, 123a, 123b, 123c, 123d may be changed accordingly. Therefore, the first and second sensing elements 113a, 113b, 113c, 113d, 123a, 123b, 123c, 123d in the circuit diagram of FIG. 9 are illustrated as variable resistances. However, the present disclosure is not limited thereto.

As shown in FIG. 9, the first sensing elements 113a, 113b, 113c, 113d may be electrically coupled to form a first Wheatstone bridge WB1, wherein the two first sensing elements 113b, 113c located within the first projection range 119 do not share the same node among the first Wheatstone bridge WB1. In the present disclosure, the term related to “two elements do not share the same node” refers that the two elements are not directly connected to each other in the circuit. For example, as shown in FIG. 9, it can be considered that the first sensing elements 113b, 113c may be indirectly connected to each other via an ammeter A1 in the circuit, while each of the first sensing element 113b and the first sensing element 113c is directly connected to each of the first sensing element 113a and the first sensing element 113d respectively. Moreover, the first Wheatstone bridge WB1 form by the electrical coupling of the first sensing elements 113a, 113b, 113c, 113d may connect with the calculation unit 130c of the computing module 13 through the ammeter A1.

When the plurality of batteries BT expand and thus push each other along a first direction D1, the pushing force may be concentrated on the first protrusions 112 to deform the first walls 111, such that the first sensing elements 113b, 113c located within the first projection range 119 have relatively large electrical resistance changes therein with respect to the first sensing elements 113a, 113d located outside of the first projection range 119. More specific, there are extension strains generated on the first sensing elements 113b, 113c to increase the electrical resistances of the first sensing elements 113b, 113c, such that the electrical resistance changes of the first sensing elements 113b, 113c are larger than zero. Relatively, there are compression strains generated on the first sensing elements 113a, 113d to reduce the electrical resistances of the first sensing elements 113a, 113d, such that the electrical resistance changes of the first sensing elements 113a, 113d are smaller than zero. Since the first sensing elements 113b, 113c having the relatively large electrical resistance changes do not share the same node in the first Wheatstone bridge WB1, a relatively large potential difference is generated on two opposite sides of the ammeter A1. As such, the ammeter A1 can measure a relatively large current flowing therethrough. Accordingly, the sensitivity of measurement by the ammeter A1 can be increased, and the influence on the measurement result of the ammeter A1 caused by noise can be reduced.

As shown in FIG. 9, the second sensing elements 123a, 123b, 123c, 123d may be electrically coupled to form a second Wheatstone bridge WB2, wherein the two second sensing elements 123b, 123c located within the second projection range 129 do not share the same node among the second Wheatstone bridge WB2. For example, as shown in FIG. 9, it can be considered that the second sensing elements 123b, 123c may be indirectly connected to each other via an ammeter A2 in the circuit, while each of the second sensing element 123b and the second sensing element 123c is directly connected to each of the second sensing element 123a and the second sensing element 123d respectively. Moreover, the second Wheatstone bridge WB2 form by the electrical coupling of the second sensing elements 123a, 123b, 123c, 123d may connect with the calculation unit 130c of the computing module 13 through the ammeter A2.

When the plurality of batteries BT expand and thus push each other along a second direction D2, the pushing force may be concentrated on the second protrusion 122 to deform the second wall 121, such that the second sensing elements 123b, 123c located within the second projection range 129 have relatively large electrical resistance changes therein with respect to the second sensing elements 123a, 123d located outside of the second projection range 129. More specific, there are extension strains generated on the second sensing elements 123b, 123c to increase the electrical resistances of the second sensing elements 123b, 123c, such that the electrical resistance changes of the second sensing elements 123b, 123c are larger than zero. Relatively, there are compression strains generated on the second sensing elements 123a, 123d to reduce the electrical resistances of the second sensing elements 123a, 123d, such that the electrical resistance changes of the second sensing elements 123a, 123d are smaller than zero. Since the second sensing elements 123b, 123c having the relatively large electrical resistance changes do not share the same node in the second Wheatstone bridge WB2, a relatively large potential difference is generated on two opposite sides of the ammeter A2. As such, the ammeter A2 can measure a relatively large current flowing therethrough. Accordingly, the sensitivity of measurement by the ammeter A2 can be increased, and the influence on the measurement result of the ammeter A2 caused by noise can be reduced.

Please be noted that the ammeter A1 or the ammeter A2 is not intended to restrict the present disclosure. In some embodiments of the present disclosure, the ammeter may be replaced by a voltmeter or other similar members.

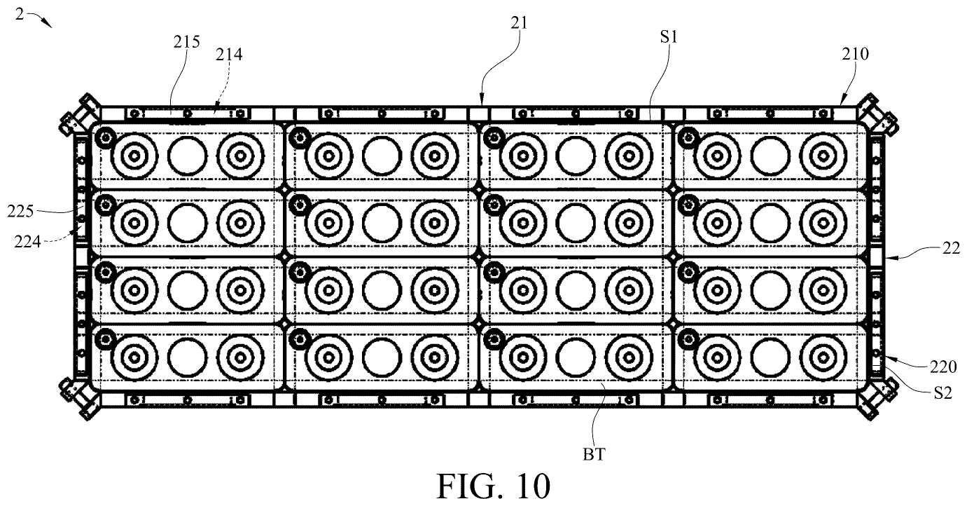

Please be noted that in the abovementioned embodiment, the battery pack arranged in the 2×2 array to which the battery pack detection system 1 is applied is not intended to restrict the present disclosure. Please refer to FIG. 10, which is a top view of a battery pack detection system according to another embodiment of the present disclosure combined with a battery pack where a computing module is removed. Please be noted that a battery pack detection system 2 provided in this embodiment is similar to the battery pack detection system 1 in the abovementioned embodiment in structure, and only difference will be illustrated in the following.

In this embodiment, the first sensing modules 21 respectively disposed on the two opposite first sides S1 (they can also be considered as one first side and another first side) of the battery pack, and each first sensing module 21 includes M (e.g., 4) first sensing parts 210, but the present disclosure is not limited thereto. The second sensing modules 22 respectively disposed on the two opposite second sides S2 (they can also be considered as one second side and another second side) of the battery pack, and each second sensing module 22 includes N (e.g., 4) second sensing parts 220, but the present disclosure is not limited thereto.

Moreover, each first sensing module 21 may further include four first protectors 215 that respectively cover the first recesses 214 corresponding thereto. Each second sensing module 22 may further include two second protectors 225 that each cover two second recesses 224.

The battery BT in the battery pack may expand due to battery degradation regardless of the arrangement of the battery pack. For this end, any one of the battery pack detection systems 1, 2 in the abovementioned embodiments and battery pack detection systems in other embodiments of the present disclosure can be used to determine whether each battery BT in the battery pack excessively expand.

Specifically, please refer to FIG. 1 to FIG. 11 for taking the battery pack detection system 1 as an example. When the plurality of batteries BT contact against at least one first protrusion 112 along the first direction DI thus to deform the corresponding first wall 111 due to expansion of at least one of the plurality of batteries BT, the two first sensing elements 113b, 113c located within the first projection range 119 can be forced to generate tensile deformations by, for example, a tension force, such that tensile strains are applied on the first sensing elements 113b, 113c so as to, for example, increase electrical resistances of the first sensing elements 113b, 113c as the corresponding first wall 111 deforms at the second surface 111b thereof. On the other hand, the another two first sensing elements 113a, 113d located outside of the first projection range 119 can be forced to generate compression deformations by, for example, a compression force, such that compressive strains are applied on the first sensing elements 113a, 113d so as to, for example, reduce electrical resistances of the first sensing elements 113a, 113d as the corresponding first wall 111 deforms at the second surface 111b thereof. Moreover, these changes of the electrical resistances can be correlated to directional deformations through, for example, conversion by an instrument (not shown).

Similarly, when the plurality of batteries BT contact against at least one second protrusion 122 along the second direction D2 thus to deform the corresponding second wall 121 due to expansion of at least one of the plurality of batteries BT, the two second sensing elements 123b, 123c located within the second projection range 129 can be forced to generate tensile deformations by, for example, a tension force, such that tensile strains are applied on the second sensing elements 123b, 123c so as to, for example, increase electrical resistances of the second sensing elements 123b, 123c as the corresponding second wall 121 deforms at the second surface 121b thereof. On the other hand, the another two second sensing elements 123a, 123d located outside of the second projection range 129 can be forced to generate compression deformations by, for example, a compression force, such that compressive strains are applied on the second sensing elements 123a, 123d so as to, for example, reduce electrical resistances of the second sensing elements 123a, 123d as the corresponding second wall 121 deforms at the second surface 121b thereof. Moreover, these changes of the electrical resistances can be correlated to directional deformations through, for example, conversion by an instrument (not shown).

Please be noted that the definitions of the first projection range 119 and the second projection range 129 are not restricted by the boundaries or contours of the first protrusion 112 and the second protrusion 122, respectively. In actual situation, the area on which the tensile strains are applied can be simulated by the finite element method so as to accurately define the first projection range and the second projection range. Therefore, in some embodiments of the present disclosure, the first projection range and the second projection range may be defined as being slightly larger than the boundaries or contours of the first protrusion and the second protrusion, respectively, such that the first sensing elements and the second sensing elements respectively disposed within these ranges can still be forced by a tensile force to increase electrical resistances thereof. Alternatively, in some other embodiments of the present disclosure, the first projection range and the second projection range may be defined as being smaller than the boundaries or contours of the first protrusion and the second protrusion, respectively, such that the first sensing elements and the second sensing elements respectively disposed within these ranges can be forced by a relatively large tensile force to enhance the increasing of the electrical resistances thereof.

Moreover, the connectors 14 can be used to adjust the combined forces applied on the first sensing modules 11 and the second sensing modules 12, so that pre-compression stresses onto the first protrusions 112 and the second protrusions 122 applied by the batteries BT can be adjusted in order to improve the sensitivities of electrical signals generated by the first sensing elements 113b, 113c and the second sensing elements 123b, 123c.

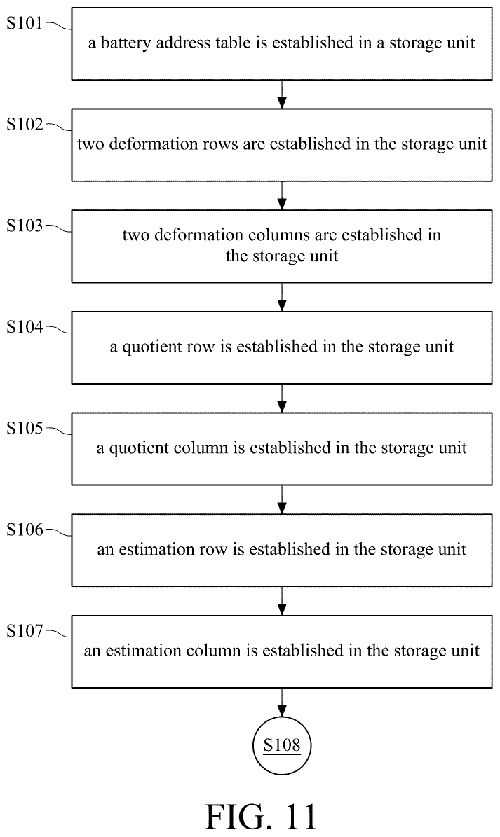

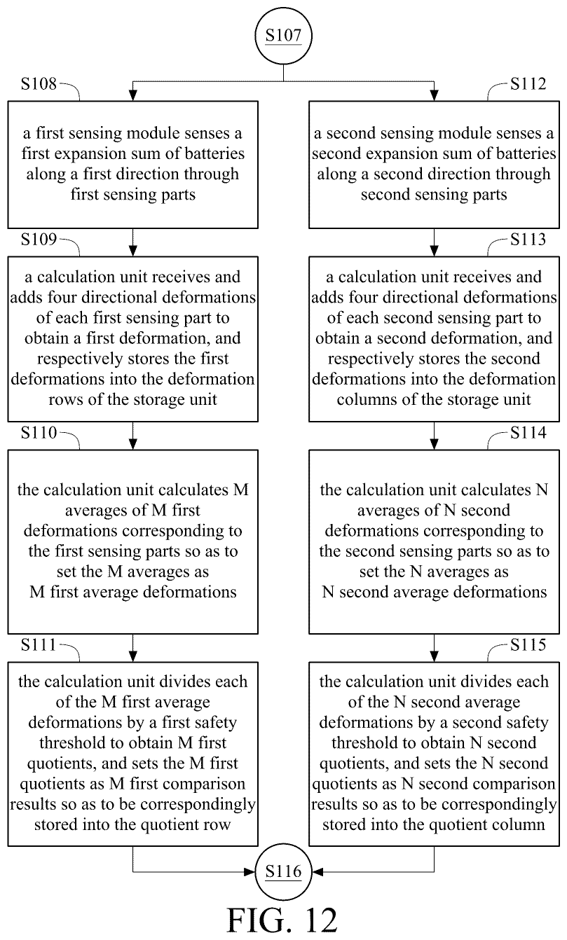

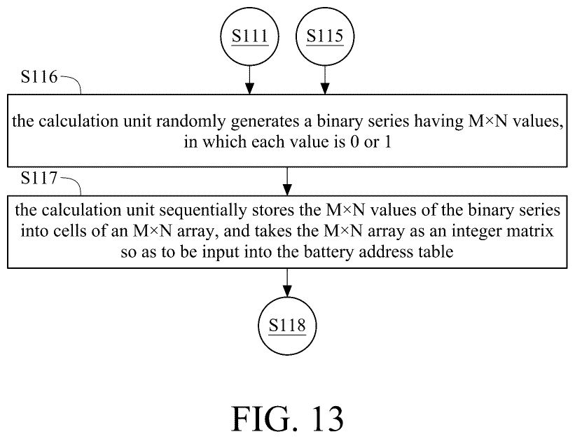

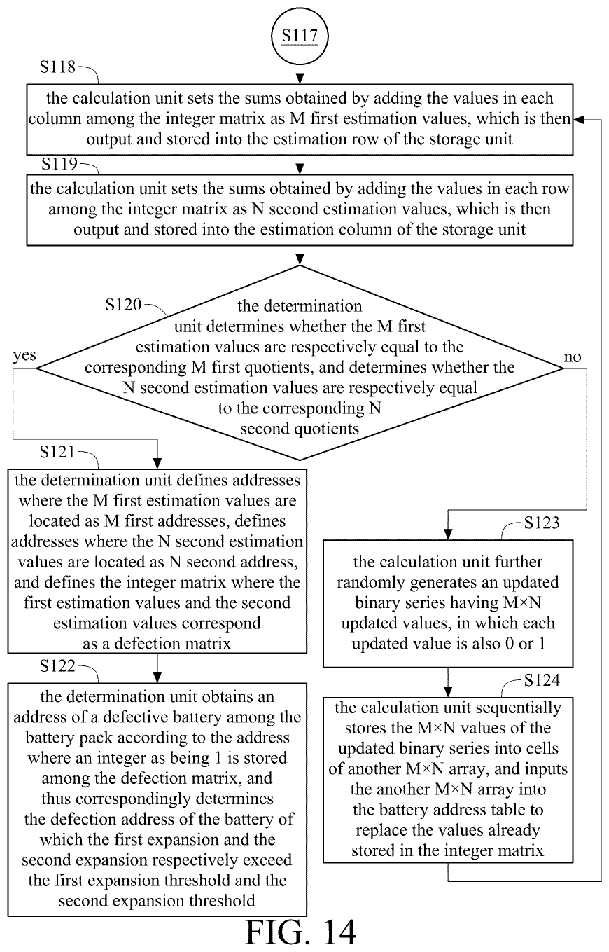

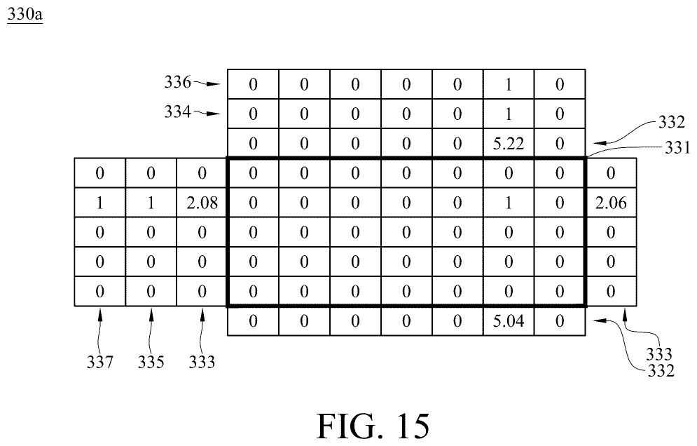

In the following description, please refer to FIG. 11 to FIG. 15, where FIG. 11 to FIG. 14 are flow charts of a detection method for the battery pack module according to further another embodiment of the present disclosure, and FIG. 15 is a schematic view showing data stored in a storage unit that is used in a detection method for the battery pack module according to further another embodiment of the present disclosure. Please be noted that a battery pack detection system 3 is used as an example for assisting in understanding the present disclosure, but the implementation of the detection method for the battery pack module of the present disclosure is not limited to the battery pack detection system 3. In some embodiments of the present disclosure, any one of the abovementioned battery pack detection systems 1, 2 and other battery pack detection systems of the present disclosure can also be used to perform the detection method for the battery pack module of the present disclosure. Moreover, please be noted that the battery pack detection system 3 provided in this embodiment is similar to the battery pack detection system 1 in the abovementioned embodiment in structure, and only difference will be illustrated in the following.

Firstly, in the step S101, a battery address table 331 is established in the storage unit 330a. The battery address table 331 includes M×N address cells, wherein M may be, for example, 7, and N may be, for example, 5.

Then, in the step S102, two deformation rows 332 are respectively established above and below the battery address table 331 in the storage unit 330a. Each deformation row 332 includes M row cells.

Then, in the step S103, two deformation columns 333 are respectively established on the left and right of the battery address table 331 in the storage unit 330a. Each deformation column 333 includes N column cells.

The, in the step S104, a quotient row 334 is established above the battery address table 331 and the deformation rows 332 in the storage unit 330a. The quotient row 334 includes M first quotient cells.

Then, in the step S105, a quotient column 335 is established on the left of the battery address table 331 and the deformation columns 333 in the storage unit 330a. The quotient column 335 includes N second quotient cells.

Then, in the step S106, an estimation row 336 is established above the quotient row 334 in the storage unit 330a. The estimation row 336 includes M first estimation cells.

Then, in the step S107, an estimation column 337 is established on the left of the quotient column 335 in the storage unit 330a. The estimation column 337 includes N second estimation cells.

Please be noted that the abovementioned steps S101 to S107 may be performed in arbitrary sequence, and the present disclosure is not limited thereto. Also, please be noted that the positions of the abovementioned deformation rows 332, deformation columns 333, quotient row 334, quotient column 335, estimation row 336 and estimation column 337 are not intended to restrict the present disclosure.

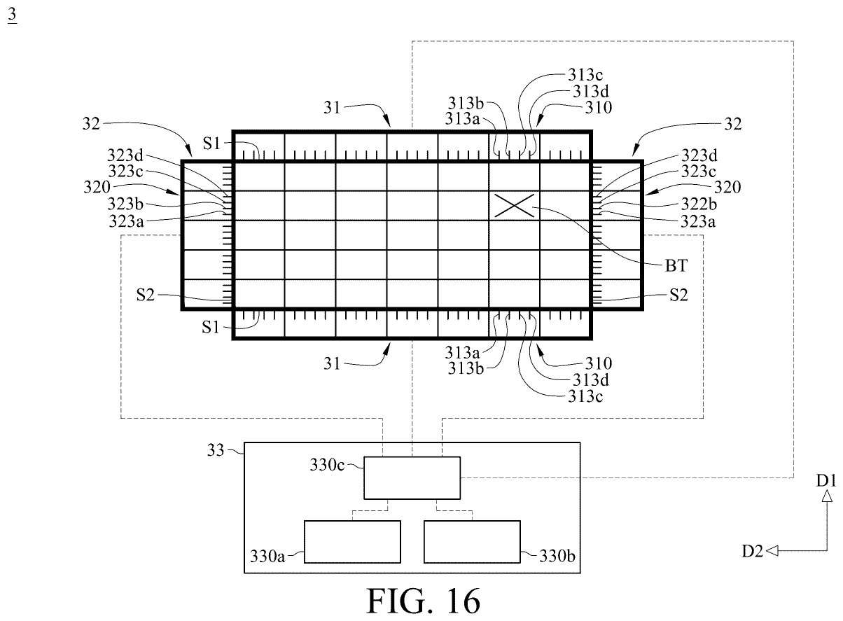

In the following for illustrating the step S108, please further refer to FIG. 16 together with FIG. 11 to FIG. 15, where FIG. 16 is a schematic and top view of a battery pack detection system according to further another embodiment of the present disclosure combined with a battery pack where a computing module is removed.

In the step S108, each first sensing module 31 can sense a first expansion sum of N batteries BT located at the same column along the first direction D1 through each of the M first sensing parts 310 thereof. Specifically, considering the quantity of expanded batteries BT may be more than one in some cases, when a plurality of batteries BT expand along the first direction D1, the expanded batteries BT therefore push each other along the first direction D1. Herein, the expansion amount of each battery BT along the first direction D1 is defined as a first expansion, and the sum calculated by adding the first expansions of the N batteries BT arranged along the first direction D1 is defined as the first expansion sum. The expanded batteries BT pushing each other along the first direction D1 apply a force on the first sensing parts 310, such that strains are applied on the first sensing elements 313a, 313b, 313c, 313d of the first sensing parts 310. By doing so, as set forth, electrical resistances of the first sensing elements 313a, 313b, 313c, 313d are changed and can be used for obtaining four corresponding directional deformations through conversion. Accordingly, obtaining the four directional deformations through the first sensing elements 313a, 313b, 313c, 313d of each first sensing part 310 can be considered as sensing the first expansion sum of the N batteries BT along the first direction D1 by each first sensing part 310. In this embodiment, a battery BT located at the second row and the sixth column among the battery pack excessively expands in actual fact, as the X mark denoted in FIG. 16. Therefore, four directional deformations can be obtained through the corresponding first sensing elements 313a, 313b, 313c, 313d.

Then, in the step S109, the calculation unit 330c of the computing module 33 receives and adds the four directional deformations of each first sensing part 310 to obtain a first deformation, and the calculation unit 330c respectively stores the total quantity of 2 M of the first deformations into the total quantity of 2 M of the row cells of the two deformation rows 332 of the storage unit 330a. Please be noted that two of the directional deformations obtained through the first sensing elements 313b, 313c have relatively large absolute values, so that the first deformation calculated by adding the four directional deformations among each first sensing part 310 still has a value not approaching 0. In this embodiment, the sums calculated by adding directional deformations that are obtained through the first sensing elements 313a, 313b, 313c, 313d among two first sensing parts 310 corresponding to the excessively expanded battery BT along the first direction D1 may be, for example, 5.22 and 5.04, while each of the sums calculated by adding directional deformations that are obtained through the first sensing elements 313a, 313b, 313c, 313d among the other first sensing parts 310 may be, for example, 0. Therefore, the values of 0, 0, 0, 0, 0, 5.22, 0 and the values of 0, 0, 0, 0, 0, 5.04, 0 are considered as the first deformations so as to be stored into the cells of the two deformation rows 332, respectively, as shown in FIG. 15. Please be noted that adding the four directional deformations among each first sensing part 310 is for enhancing the sensing sensitivity, but the present disclosure is not limited thereto.

Then, in the step S110, the calculation unit 330c calculates M averages of M first deformations corresponding to the M first sensing parts 310 of one first sensing module 31 and M first deformations corresponding to the M first sensing parts 310 of another first sensing module 31 so as to set the M averages as M first average deformations. In this embodiment, the first average deformations may be, for example, 0, 0, 0, 0, 0, 5.13, 0.

Then, in the step S111, the calculation unit 330c divides each of the M first average deformations by the first safety threshold to obtain M first quotients as being integers each equal to or greater than 0, and the calculation unit 330c sets the M first quotients as M first comparison results so as to be correspondingly stored into the M first quotient cells of the quotient row 334. Please be noted that the M first comparison results may contain two situations. One situation is caused by the value of one first average deformation exceeding the first safety threshold; that is, the corresponding first quotient is greater than 0. The other one situation is caused by the value of one first average deformation less than the first safety threshold; that is, the corresponding first quotient is equal to 0. In this embodiment, the first safety threshold may be, for example, 4. As such, the calculated first quotients may be, for example, 0, 0, 0, 0, 0, 1, 0. Therefore, the values of 0, 0, 0, 0, 0, 1, 0 are set as the first comparison results so as to be stored in the cells of the quotient row 334, as shown in FIG. 15. If one first average deformation exceeds the first safety threshold, the corresponding first quotient is an integer greater than 1, which means at least one battery BT among the corresponding batteries BT may excessively expand along the first direction D1. The greater the value of one first quotient, the more serious the corresponding battery BT expand. In this embodiment, the first quotients are integer parts, which are calculated by dividing the first safety threshold into the first average deformations. This calculation excludes the remainder parts and uses one definition of the quotient in mathematics, specifically Euclidean division. However, the present disclosure is not limited thereto. In some embodiments of the present disclosure, the first quotients may be integers by rounding the calculation values to the nearest integers. The calculation values are calculated by dividing the first safety threshold into the first average deformations and uses another definition of the quotient in mathematics, specifically general division. For example, in the general division, if one calculation value is 1.3 and another calculation value is 0.8, they can be rounded to the nearest integer both as being 1.0. By using the general division, the first quotients may also be used to obtain the quantity of the first average deformations exceeding the first safety threshold.

Meanwhile, in the step S112, each second sensing module 32 can sense a second expansion sum of M batteries BT located at the same row along the second direction D2 through each of the N second sensing parts 320 thereof. Specifically, considering the quantity of expanded batteries BT may be more than one in some cases, when a plurality of batteries BT expand along the second direction D2, the expanded batteries BT therefore push each other along the second direction D2. Herein, the expansion amount of each battery BT along the second direction D2 is defined as a second expansion, and the sum calculated by adding the second expansions of the M batteries BT arranged along the second direction D2 is defined as the second expansion sum. The expanded batteries BT pushing each other along the second direction D2 apply a force on the second sensing parts 320, such that strains are applied on the second sensing elements 323a, 323b, 323c, 323d of the second sensing parts 320. By doing so, as set forth, electrical resistances of the second sensing elements 323a, 323b, 323c, 323d are changed and can be used for obtaining four corresponding directional deformations through conversion. Accordingly, obtaining the four directional deformations through the second sensing elements 323a, 323b, 323c, 323d of each second sensing part 320 can be considered as sensing the second expansion sum of M batteries BT along the second direction D2 by each second sensing part 320. In this embodiment, the battery BT denoted as the X mark in FIG. 16 among the battery pack (i.e., the battery BT located at the second row and the sixth column) excessively expands in actual fact. Therefore, four directional deformations can be obtained through the corresponding second sensing elements 323a, 323b, 323c, 323d.

Then, in the step S113, the calculation unit 330c receives and adds the four directional deformations of each second sensing part 320 to obtain a second deformation, and the calculation unit 330c respectively stores the total quantity of 2 N of the second deformations into the total quantity of 2 N of the column cells of the two deformation columns 333 of the storage unit 330a. Please be noted that two of the directional deformation obtained through the second sensing elements 323b, 323c have relatively large absolute values, so that the second deformation calculated by adding the four directional deformations among each second sensing part 320 still has a value not approaching 0. In this embodiment, the sums calculated by adding directional deformations that are obtained through the second sensing elements 323a, 323b, 323c, 323d among two second sensing parts 320 corresponding to the excessively expanded battery BT along the second direction D2 may be, for example, 2.08 and 2.06, while each of the sums calculated by adding directional deformations that are obtained through the second sensing elements 323a, 323b, 323c, 323d among the other second sensing parts 320 may be, for example, 0. Therefore, the values of 0, 2.08, 0, 0, 0 and the values of 0, 2.06, 0, 0, 0 are considered as the second deformations so as to be stored into the cells of the two deformation columns 333, respectively, as shown in FIG. 15. Please be noted that adding the four directional deformations among each second sensing part 320 is for enhancing the sensing sensitivity, but the present disclosure is not limited thereto.

Then, in the step S114, the calculation unit 330c calculates N averages of N second deformations corresponding to the N second sensing parts 320 of one second sensing module 32 and N second deformations corresponding to the N second sensing parts 320 of another second sensing module 32 so as to set the N averages as N second average deformations. In this embodiment, the second average deformations may be, for example, 0, 2.07, 0, 0, 0.

Then, in the step S115, the calculation unit 330c divides each of the N second average deformations by the second safety threshold to obtain N second quotients as being integers each equal to or greater than 0, and the calculation unit 330c sets the N second quotients as N second comparison results so as to be correspondingly stored into the N second quotient cells of the quotient column 335. Please be noted that the N second comparison results may contain two situations. One situation is caused by the value of one second average deformation exceeding the second safety threshold; that is, the corresponding second quotient is greater than 0. The other one situation is caused by the value of one second average deformation less than the second safety threshold; that is, the corresponding second quotient is equal to 0. In this embodiment, the second safety threshold may be, for example, 2. As such, the calculated second quotients may be, for example, 0, 1, 0, 0, 0. Therefore, the values of 0, 1, 0, 0, 0 are set as the second comparison results so as to be stored in the cells of the quotient column 335, as shown in FIG. 15. If one second average deformation exceeds the second safety threshold, the corresponding second quotient is an integer greater than 1, which means at least one battery BT among the corresponding batteries BT may excessively expand along the second direction D2. The greater the value of one second quotient, the more serious the corresponding battery BT expand. In this embodiment, the second quotients are integer parts, which are calculated by dividing the second safety threshold into the second average deformations. This calculation excludes the remainder parts and uses one definition of the quotient in mathematics, specifically Euclidean division. However, the present disclosure is not limited thereto. In some embodiments of the present disclosure, the second quotients may be integers by rounding the calculation values to the nearest integers. The calculation values are calculated by dividing the second safety threshold into the second average deformations and uses another definition of the quotient in mathematics, specifically general division. For example, in the general division, if one calculation value is 1.3 and another calculation value is 0.8, they can be rounded to the nearest integer both as being 1.0. By using the general division, the second quotients may also be used to obtain the quantity of the second average deformations exceeding the second safety threshold.

Please be noted that the abovementioned steps S108 to S111 and the abovementioned steps S112 to S115 may be performed simultaneously or in sequence, and the present disclosure is not limited thereto.

The determination unit 330b can suppose that the first expansion and the second expansion of one battery BT among the battery pack respectively exceed a first expansion threshold and a second expansion threshold, and the determination unit 330b can define said one battery BT as a defective battery and can define an address where the defective battery is located as a defection address. The following steps can be used to find out said defective battery and said defection address. In some cases, the first expansion threshold and the second expansion threshold may be respectively considered as being equal to the first safety threshold and the second safety threshold.

Then, in the step S116, the calculation unit 330c randomly generates a binary series having M×N values, in which each value is 0 or 1. In this embodiment, the quantity of M×N values may be, for example, 35, and the binary series may be, for example, 0, 0, . . . , 1, . . . , 0, 0, in which the 13th value is 1 and each of the 34 remaining values is 0.

Then, in the step S117, the calculation unit 330c sequentially stores the M×N values of the said binary series into cells of an M×N array, and the calculation unit 330c takes the M×N array as an integer matrix so as to be input into the battery address table 331. The said integer matrix has M columns and N rows, and each address of the integer matrix contains only one integer as being 0 or 1. In this embodiment, the calculation unit 330c may, for example, sequentially store the 35 values of the said binary series into the cells in a 7×5 array, and the calculation unit 330c takes the 7×5 array as the said integer matrix. The result of inputting the integer matrix into the battery address table 331 is shown in FIG. 15, in which the value in the cell located at the second row and the sixth column is 1 and each value in the remaining cells is 0.

Please be noted that the generation manner of the integer matrix in the steps S116 to S117 is only exemplary, and the present disclosure is not limited thereto. In some embodiments of the present disclosure, an integer matrix may be generated in other suitable manner.

Then, in the step S118, the calculation unit 330c calculates M column sums obtained by adding the values in each column among the said integer matrix, and the calculation unit 330c respectively sets the said M column sums as M first estimation values, which is then output into the storage unit 330a so as to be correspondingly stored into M first estimation cells of the estimation row 336. In this embodiment, the first estimation values among the first estimation cells of the estimation row 336 may be, for example, 0, 0, 0, 0, 0, 1, 0, as shown in FIG. 15.

Then, in the step S119, the calculation unit 330c calculates N row sums obtained by adding the values in each row among the said integer matrix, and the calculation unit 330c respectively sets the said N row sums as N second estimation values, which is then output into the storage unit 330a so as to be correspondingly stored into N second estimation cells of the estimation column 337. In this embodiment, the second estimation values among the second estimation cells of the estimation column 337 may be, for example, 0, 1, 0, 0, 0, as shown in FIG. 15.

Then, in the step S120, the determination unit 330b determines whether the said M first estimation values are respectively equal to the said M first quotients corresponding thereto, and the determination unit 330b determines whether the said N second estimation values are respectively equal to the said N second quotients corresponding thereto.

If the determination result of the determination unit 330b in the step S120 is true, then the step S121 is performed. In the step S121, the determination unit 330b defines the addresses where the said M first estimation values are located as M first addresses of the said M first average deformations corresponding thereto, defines the addresses where the said N second estimation values are located as N second address of the said N second average deformations corresponding thereto, and defines the integer matrix where the first estimation values and the second estimation values correspond as a defection matrix. In this embodiment, as shown in FIG. 15, the first estimation values among the estimation row 336 are respectively equal to the first quotients among the quotient row 334 corresponding thereto, and the second estimation values among the estimation column 337 are respectively equal to the second quotients among the quotient column 335 corresponding thereto. Therefore, the integer matrix shown in the battery address table 331 of FIG. 15 can be considered as the defection matrix.

Then, in the step S122, the determination unit 330b obtains the address of the defective battery among the battery pack according to the address where an integer as being 1 is stored among the defection matrix, and thus the determination unit 330b correspondingly determines the defection address of the battery BT of which the first expansion and the second expansion respectively exceed the first expansion threshold and the second expansion threshold. Accordingly, the defective battery (the excessively expanded battery BT) can be found so as to be replaced by a new battery in good health. In this embodiment, the address of the integer as being 1 stored among the defection matrix is the second row and the sixth column, which can correspond to the battery BT located at the second row and the sixth column among the battery pack. As such, the battery BT located at the second row and the sixth column can be determined as the defective battery, which is consistent with the battery BT denoted as the X mark in FIG. 16.

If the determination result of the determination unit 330b in the step S120 is false, it means the said integer matrix is not determined as a defection matrix, and then the step S123 is performed. For example, if the 12th value among the said binary series, for example, is 1, with each of the remaining 34 values being 0, the second estimation values obtained by the abovementioned manner are still 0, 1, 0, 0, 0, but the first estimation values obtained by the abovementioned manner are, however, 0, 0, 0, 0, 1, 0, 0. As such, the first estimation values are not respectively equal to the first quotients corresponding thereto, and thus the determination result of the determination unit 330b in the step S120 is false.

In the step S123, the calculation unit 330c further randomly generates an updated binary series having M×N updated values, in which each updated value is also 0 or 1. However, the updated binary series further generated by the calculation unit 330c is not identical to the said binary series. In other words, at least one of said updated values among the said updated binary series is unequal to at least one value at the corresponding sequence among the said binary series.

Then, in the step S124, the calculation unit 330c sequentially stores the M×N values of the said updated binary series into cells of another M×N array, and the calculation unit 330c inputs the another M×N array into the battery address table to replace the values already stored in the integer matrix. Then, the step S118 is performed again until the determination result of the determination unit 330b in the step S120 is true, and the excessively expanded battery BT can be found.

Please be noted when the determination result in the step S120 is false, the step S116 may be performed next. However, the present disclosure is not limited thereto.

Please be noted that in the step S110 and the step S111, the M first quotients may be alternatively obtained by dividing the first safety threshold into only one set of the M first deformations so as to be considered as the M first comparison results, and the present disclosure is not limited thereto.

Please be noted that in the step S114 and the step S115, the N second quotients may be alternatively obtained by dividing the second safety threshold into only one set of the N second deformations so as to be considered as the N second comparison results, and the present disclosure is not limited thereto.

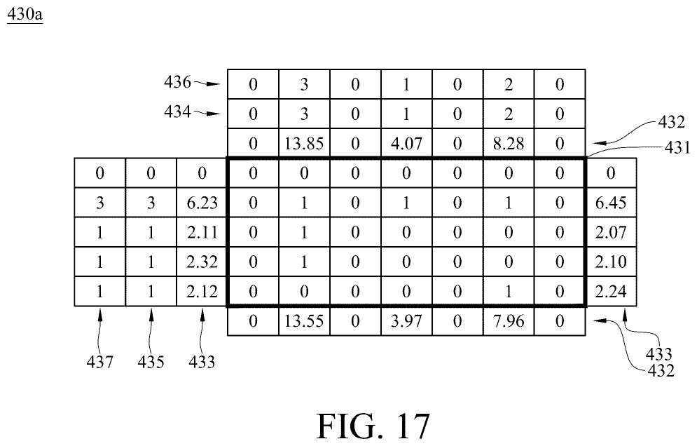

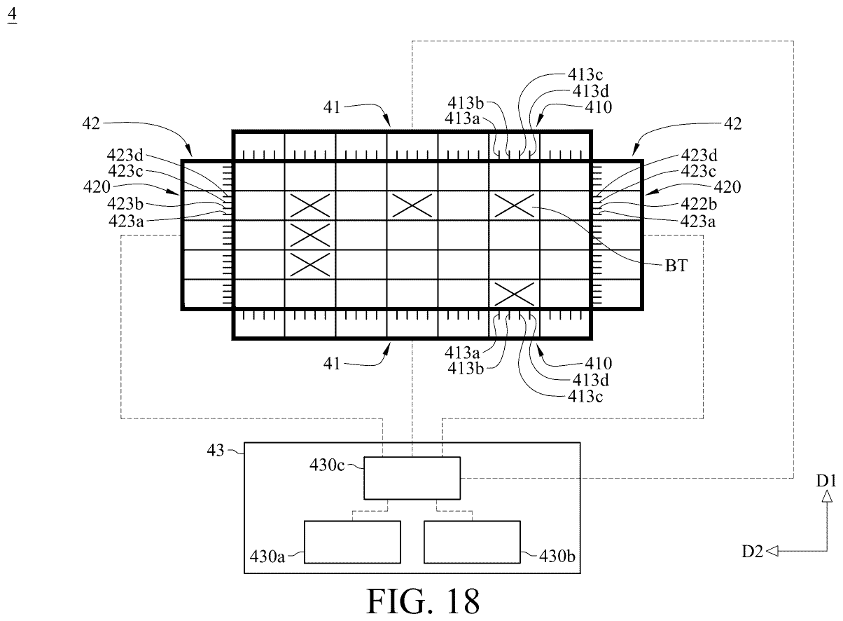

In general, excessive expansions of a plurality of batteries among one battery pack are less likely occurred at the same time, so in the above embodiment, one excessively expanded battery located at the second row and the sixth column is illustrated as an example. However, the present disclosure is not limited thereto. Please further refer to FIG. 17 to FIG. 18 together with FIG. 11 to FIG. 14, where FIG. 17 is a schematic view showing data stored in a storage unit that is used in a detection method for the battery pack module according to still further another embodiment of the present disclosure, and FIG. 18 is a schematic and top view of a battery pack detection system according to still further another embodiment of the present disclosure combined with a battery pack where a computing module is removed. Please be noted that a battery pack detection system 4 is used as an example for assisting in understanding the present disclosure, but the implementation of the detection method for the battery pack module of the present disclosure is not limited to the battery pack detection system 4. Moreover, please be noted that the battery pack detection system 4 provided in this embodiment is similar to the battery pack detection system 1 in the abovementioned embodiment in structure and is similar to the battery pack detection system 3 in the previous embodiment in performance. Therefore, only difference will be illustrated in the following.

Firstly, as the battery pack detection system 3, the step S101 to the step S107 are performed, and the similar description will not be repeated again.

Then, in the step S108, each first sensing module 41 can sense a first expansion sum of N batteries BT located at the same column along the first direction D1 through each of the M first sensing parts 410 thereof. In this embodiment, six batteries BT located respectively at the second row and the second column, the second row and the fourth column, the second row and the sixth column, the third row and the second column, the fourth row and the second column and the fifth row and the sixth column among the battery pack excessively expand in actual fact, as the X marks denoted in FIG. 18. Therefore, four directional deformations can be obtained through the corresponding first sensing elements 413a, 413b, 413c, 413d of each first sensing part 410.

Then, in the step S109, the calculation unit 430c of the computing module 43 receives and adds the four directional deformations of each first sensing part 410 to obtain a first deformation, and the calculation unit 430c respectively stores the total quantity of 2 M of the first deformations into the total quantity of 2 M of the row cells of the two deformation rows 432 of the storage unit 430a. In this embodiment, the sum calculated by adding four directional deformations that are obtained through the first sensing elements 413a, 413b, 413c, 413d located at each of seven first sensing parts 410 among one first sensing module 41 may be, for example, 0, 13.85, 0, 4.07, 0, 8.28, 0, while the sum calculated by adding four directional deformations that are obtained through the first sensing elements 413a, 413b, 413c, 413d located at each of seven first sensing parts 410 among the other first sensing module 41 may be, for example, 0, 13.55, 0, 3.97, 0, 7.96, 0. Therefore, the values of 0, 13.85, 0, 4.07, 0, 8.28, 0 and the values of 0, 13.55, 0, 3.97, 0, 7.96, 0 are considered as the first deformations so as to be stored into the cells of the two deformation rows 432, respectively, as shown in FIG. 17. Please be noted that adding the four directional deformations among each first sensing part 410 is for enhancing the sensing sensitivity, but the present disclosure is not limited thereto.

Then, in the step S110, the calculation unit 430c calculates M averages of M first deformations corresponding to the M first sensing parts 410 of one first sensing module 41 and M first deformations corresponding to the M first sensing parts 410 of another first sensing module 41 so as to set the M averages as M first average deformations. In this embodiment, M may be, for example, 7, and the seven first average deformations may be, for example, 0, 13.70, 0, 4.02, 0, 8.12, 0.

Then, in the step S111, the calculation unit 430c divides each of the M first average deformations by the first safety threshold to obtain M first quotients as being integers each equal to or greater than 0, and the calculation unit 430c sets the M first quotients as M first comparison results so as to be correspondingly stored into the M first quotient cells of the quotient row 434. In this embodiment, the first safety threshold may be, for example, 4. As such, the calculated first quotients may be, for example, 0, 3, 0, 1, 0, 2, 0. Therefore, the values of 0, 3, 0, 1, 0, 2, 0 are set as the first comparison results so as to be stored in the cells of the quotient row 434, as shown in FIG. 17. If one first average deformation exceeds the first safety threshold, the corresponding first quotient is an integer greater than 1, which means at least one battery BT among the corresponding batteries BT may excessively expand along the first direction D1. The greater the value of one first quotient, the more serious the corresponding batteries BT expand.

Meanwhile, in the step S112, each second sensing module 42 can sense a second expansion sum of M batteries BT located at the same row along the second direction D2 through each of the N second sensing parts 420 thereof. In this embodiment, as set forth, the batteries BT denoted as the X marks in FIG. 18 among the battery pack (i.e., the six batteries BT located at the second row and the second column, the second row and the fourth column, the second row and the sixth column, the third row and the second column, the fourth row and the second column and the fifth row and the sixth column) excessively expand in actual fact. Therefore, four directional deformations can be obtained through the corresponding second sensing elements 423a, 423b, 423c, 423d of each second sensing part 420.

Then, in the step S113, the calculation unit 430c receives and adds the four directional deformations of each second sensing part 420 to obtain a second deformations, and the calculation unit 430c respectively stores the total quantity of 2 N of the second deformations into the total quantity of 2 N of the column cells of the two deformation columns 433 of the storage unit 430a. In this embodiment, the sum calculated by adding four directional deformations that are obtained through the second sensing elements 423a, 423b, 423c, 423d located at each of five second sensing parts 420 among one second sensing module 42 may be, for example, 0, 6.23, 2.11, 2.32, 2.12, while the sum calculated by adding four directional deformations that are obtained through the second sensing elements 423a, 423b, 423c, 423d located at each of five second sensing parts 420 among the other second sensing module 42 may be, for example, 0, 6.45, 2.07, 2.10, 2.24. Therefore, the values of 0, 6.23, 2.11, 2.32, 2.12 and the values of 0, 6.45, 2.07, 2.10, 2.24 are considered as the second deformations so as to be stored into the cells of the two deformation columns 433, respectively, as shown in FIG. 17. Please be noted that adding the four directional deformations among each second sensing part 420 is for enhancing the sensing sensitivity, but the present disclosure is not limited thereto.

Then, in the step S114, the calculation unit 430c calculates N averages of N second deformations corresponding to the N second sensing parts 420 of one second sensing module 42 and N second deformations corresponding to the N second sensing parts 420 of another second sensing module 42 so as to set the N averages as N second average deformations. In this embodiment, N may be, for example, 5, and the five second average deformations may be, for example, 0, 6.34, 2.09, 2.21, 2.18.

Then, in the step S115, the calculation unit 430c divides each of the N second average deformations by the second safety threshold to obtain N second quotients as being integers each equal to or greater than 0, and the calculation unit 430c sets the N second quotients as N second comparison results so as to be correspondingly stored into the N second quotient cells of the quotient column 435. In this embodiment, the second safety threshold may be, for example, 2. As such, the calculated second quotients may be, for example, 0, 3, 1, 1, 1. Therefore, the values of 0, 3, 1, 1, 1 are set as the second comparison results so as to be stored in the cells of the quotient column 435, as shown in FIG. 17. If one second average deformation exceeds the second safety threshold, the corresponding second quotient is an integer greater than 1, which means at least one battery BT among the corresponding batteries BT may excessively expand along the second direction D2. The greater the value of one second quotient, the more serious the corresponding batteries BT expand.

Then, in the step S116, the calculation unit 430c randomly generates a binary series having M×N values, in which each value is 0 or 1. In this embodiment, the quantity of M×N values may be, for example, 35, and the binary series may be, for example, 0, 0, 0, 0, 0, 0, 0, 0, 1, 0, 1, 0, 1, 0, 0, 1, 0, 0, 0, 0, 0, 0, 1, 0, 0, 0, 0, 0, 0, 0, 0, 0, 0, 1, 0, in which each of the 9th, 11th, 13th, 16th, 23th and 34th values is 1 and each of the 29 remaining values is 0.

Then, in the step S117, the calculation unit 430c sequentially stores the M×N values of the said binary series into cells of an M×N array, and the calculation unit 430c takes the M×N array as an integer matrix so as to be input into the battery address table 431. The said integer matrix has M columns and N rows, and each address of the integer matrix contains only one integer as being 0 or 1. In this embodiment, the calculation unit 430c may, for example, sequentially store the 35 values of the said binary series into the cells in a 7×5 array, and the calculation unit 430c takes the 7×5 array as the said integer matrix. The result of inputting the integer matrix into the battery address table 431 is shown in FIG. 17, in which each of the values in the cells located at the second row and the second column, the second row and the fourth column, the second row and the sixth column, the third row and the second column, the fourth row and the second column and the fifth row and the sixth column is 1 and each value in the remaining cells is 0.

Then, in the step S118, the calculation unit 430c calculates M column sums by adding the values in each column among the said integer matrix, and the calculation unit 430c respectively sets the said M column sums as M first estimation values, which is then output into the storage unit 430a so as to be correspondingly stored into M first estimation cells of the estimation row 436. In this embodiment, the first estimation values among the first estimation cells of the estimation row 436 may be, for example, 0, 3, 0, 1, 0, 2, 0, as shown in FIG. 17.

Then, in the step S119, the calculation unit 430c calculates N row sums by adding the values in each row among the said integer matrix, and the calculation unit 430c respectively sets the said N row sums as N second estimation values, which is then output into the storage unit 430a so as to be correspondingly stored into N second estimation cells of the estimation column 437. In this embodiment, the second estimation values among the second estimation cells of the estimation column 437 may be, for example, 0, 3, 1, 1, 1, as shown in FIG. 17.

Then, in the step S120, the determination unit 430b determines whether the said M first estimation values are respectively equal to the said M first quotients corresponding thereto, and the determination unit 430b determines whether the said N second estimation values are respectively equal to the said N second quotients corresponding thereto.

If the determination result of the determination unit 430b in the step S120 is true, then the step S121 is performed. In the step S121, the determination unit 430b defines the addresses where the said M first estimation values are located as M first addresses of the said M first average deformations corresponding thereto, defines the addresses where the said N second estimation values are located as N second address of the said N second average deformations corresponding thereto, and defines the integer matrix where the first estimation values and the second estimation values correspond as a defection matrix. In this embodiment, as shown in FIG. 17, the first estimation values among the estimation row 436 are respectively equal to the first quotients among the quotient row 434 corresponding thereto, and the second estimation values among the estimation column 437 are respectively equal to the second quotients among the quotient column 435 corresponding thereto. Therefore, the integer matrix shown in the battery address table 431 of FIG. 17 can be considered as the defection matrix.

Then, in the step S122, the determination unit 430b obtains the addresses of the defective batteries among the battery pack according to the addresses where integers as being 1 are stored among the defection matrix, and thus the determination unit 430b correspondingly determines the defection addresses of the batteries BT of which the first expansion and the second expansion respectively exceed the first expansion threshold and the second expansion threshold. Accordingly, the defective batteries (the excessively expanded batteries BT) can be found so as to be replaced by new batteries in good health. In this embodiment, the addresses of the integers as being 1 stored among the defection matrix are the second row and the second column, the second row and the fourth column, the second row and the sixth column, the third row and the second column, the fourth row and the second column and the fifth row and the sixth column, which can correspond to the six batteries BT located at the second row and the second column, the second row and the fourth column, the second row and the sixth column, the third row and the second column, the fourth row and the second column and the fifth row and the sixth column among the battery pack. As such, the six batteries BT can be determined as the defective batteries, which is consistent with the batteries BT denoted as the X marks in FIG. 18.

If the determination result of the determination unit 430b in the step S120 is false, it means the said integer matrix is not determined as a defection matrix, and then the step S123 is performed. The details of the step S123 will not be repeated herein.

Please be noted that if the binary series generated by the calculation unit 430c randomly in the step S116 is, for example, 0, 0, 0, 0, 0, 0, 0, 0, 1, 0, 1, 0, 1, 0, 0, 1, 0, 0, 0, 0, 0, 0, 0, 0, 0, 0, 1, 0, 0, 1, 0, 0, 0, 0, 0, in which each of the 9th, 11th, 13th, 16th, 27th and 30th values is 1 and each of the 29 remaining values is 0, or if the updated binary series generated by the calculation unit 430c randomly in the step S123 is, for example, 0, 0, 0, 0, 0, 0, 0, 0, 1, 0, 1, 0, 1, 0, 0, 0, 0, 0, 0, 1, 0, 0, 1, 0, 0, 0, 0, 0, 0, 1, 0, 0, 0, 0, 0, in which each of the 9th, 11th, 13th, 20th, 23th and 30th values is 1 and each of the 29 remaining values is 0, the first estimation values and the second estimation values obtained according to the abovementioned following steps are still the values of 0, 3, 0, 1, 0, 2, 0 and the values of 0, 3, 1, 1, 1, respectively, which are the same numerical series as that in the abovementioned embodiment. It means that if there are too many excessively expanded batteries at the same time, the found defection addresses corresponding to the obtained defection matrix may be slightly different from the actual defection addresses.

Taking the two binary series of the additional description in this paragraph as an example, the two corresponding defection matrixes would each have four addresses consistent with that of excessively expanded batteries in actual fact but two addresses inconsistent with that of excessively expanded batteries in actual fact. However, for the comparison result obtained in this situation, there is still a certain degree of reliability of the detection method for the battery pack module of this embodiment which can assist in quickly finding one or more excessively expanded batteries so as to be timely replaced by one or more batteries. For example, even though the two abovementioned defection matrixes each have two addresses (they can be considered as error addresses) inconsistent with two addresses (they can be considered as undetected addresses) of excessively expanded batteries in actual fact, the two error addresses in each of the two defection matrixes are still very close to the undetected addresses of the excessively expanded batteries in actual fact. Further, the two error addresses in each of the two defection matrixes are at least located at the same column or the same row as the undetected addresses of the excessively expanded batteries in actual fact. In addition, as set forth, it is not common for a plurality of batteries being excessively expanded at the same time among one battery pack. Therefore, if the excessively expanded battery can be timely detected and timely replaced to keep the excessively expanded batteries in a small quantity at the same time, the battery pack detection system and the detection method for the battery pack module of the present disclosure can still have high accuracy.

According to the battery pack detection system and the detection method for the battery pack module discussed above, only disposing the first sensing modules and the second sensing modules at the periphery of the battery pack, by utilizing the calculation and determination of the computing module, the relative address of at least one excessively expanded battery among the plurality of batteries of the battery pack can be accurately found. Accordingly, the components used in the overall battery pack detection system are cheap and simple, which can reduce the cost of detecting the battery pack and improve the space utilization between batteries of the battery pack.

Moreover, by disposing the two first sensing elements within the first projection range with the another two first sensing elements being disposed out of the first projection range, and disposing the two second sensing elements within the second projection range with the another two second sensing elements being disposed out of the second projection range, by utilizing the circuit, the sensing sensitivities of the first sensing modules and the second sensing modules can be improved.

Please be noted that the term “connect/connects/connecting with” mentioned in the present disclosure refers to a connection manner that two components are able to exchange data with each other by, for example, wire transmission or wireless transmission.

The embodiments are chosen and described in order to best explain the principles of the present disclosure and its practical applications, to thereby enable others skilled in the art best utilize the present disclosure and various embodiments with various modifications as are suited to the particular use being contemplated. It is intended that the scope of the present disclosure is defined by the following claims and their equivalents.

What is claimed is:

1. A battery pack detection system configured to surround a battery pack, wherein the battery pack comprises a plurality of batteries arranged in an M×N array, the plurality of batteries is arranged to have M individual batteries along a first side and N individual batteries along a second side, the battery pack detection system comprising:
two first sensing modules respectively disposed along the first side and another first side of the battery pack, wherein the first side and the another first side are located on opposite sides of the battery pack and each of the two first sensing modules comprises M first sensing parts configured to sense a sum of first expansions of corresponding batteries among the plurality of batteries and to output M first deformations;
two second sensing modules respectively disposed along the second side and another second side of the battery pack, wherein the second side and the another second side are located on opposite sides of the battery pack and each of the two second sensing modules comprises N second sensing parts configured to sense a sum of second expansions of corresponding batteries among the plurality of batteries and to output N second deformations, each of M and N is an integer greater than or equal to 2; and
a computing module connecting with the two first sensing modules and the two second sensing modules to receive the M first deformations of at least one of the two first sensing modules and the N second deformations of at least one of the two second sensing modules so as to obtain M first addresses corresponding to the M first deformations and N second addresses corresponding to the N second deformations to accordingly determine whether each of the plurality of batteries is a defective battery, wherein the computing module defines one of the plurality of batteries as the defective battery when a first expansion of the one of the plurality of batteries exceeds a first expansion threshold and a second expansion of the one of the plurality of batteries exceeds a second expansion threshold.

2. The battery pack detection system according to claim 1, wherein the computing module comprises:
a storage unit storing the M first deformations of each of the two first sensing modules, the N second deformations of each of the two second sensing modules, the M first addresses, the N second addresses, a first safety threshold and a second safety threshold; and
a determination unit connecting with the storage unit, the two first sensing modules and the two second sensing modules, wherein the determination unit obtains M first comparison results based on the M first deformations of each of the two first sensing modules and the first safety threshold, the determination unit obtains N second comparison results based on the N second deformations of each of the two second sensing modules and the second safety threshold, and the determination unit obtains a defection address of the defective battery located in the battery pack based on the M first comparison results of corresponding at least one of the two first sensing modules, the M first addresses, the N second comparison results of corresponding at least one of the two second sensing modules and the N second addresses.

3. The battery pack detection system according to claim 2, wherein the computing module further comprises a calculation unit that connects with the determination unit, the calculation unit divides each of the M first deformations of each of the two first sensing modules by the first safety threshold to obtain M first quotients and divides each of the N second deformations of each of the two second sensing modules by the second safety threshold to obtain N second quotients, each of the M first quotients and the N second quotients is an integer greater than or equal to 0, and the determination unit sets the M first quotients as the M first comparison results and sets the N second quotients as the N second comparison results.

4. The battery pack detection system according to claim 3, wherein the storage unit comprises:
a battery address table comprising M×N address cells;
a quotient row comprising M first quotient cells configured to respectively store the M first quotients;
a quotient column comprising N second quotient cells configured to respectively store the N second quotients;
an estimation row comprising M first estimation cells configured to store M first estimation values; and
an estimation column comprising N second estimation cells configured to store N second estimation values.

5. The battery pack detection system according to claim 4, wherein the storage unit further comprises:
two deformation rows, wherein each of the two deformation rows comprises M row cells configured to respectively store the M first deformations; and
two deformation columns, wherein each of the two deformation columns comprises N column cells configured to respectively store the N second deformations.

6. The battery pack detection system according to claim 4, wherein the calculation unit inputs an integer matrix into the battery address table, each address of the integer matrix comprises only one integer as being 0 or 1, the calculation unit calculates M column sums and N row sums of the integer matrix, the calculation unit respectively sets the M column sums as the M first estimation values and respectively sets the N row sums as the N second estimation values.

7. The battery pack detection system according to claim 6, wherein the determination unit determines the integer matrix as a defection matrix when the M first estimation values are respectively equal to the M first quotients corresponding thereto and the N second estimation values are respectively equal to the N second quotients corresponding thereto, and the determination unit obtains the defection address of the defective battery located in the battery pack based on an address located in the defection matrix where an integer as being 1 is stored.

8. The battery pack detection system according to claim 1, wherein each of the M first sensing parts comprises a first wall, a first protrusion and a first sensing group, the first wall has a first surface facing towards the plurality of batteries and a second surface facing away from the plurality of batteries, the first protrusion is disposed on the first surface of the first wall, the first sensing group is disposed on the second surface of the first wall, each of the N second sensing parts comprises a second wall, a second protrusion and a second sensing group, the second wall has a first surface facing towards the plurality of batteries and a second surface facing away from the plurality of batteries, the second protrusion is disposed on the first surface of the second wall, and the second sensing group is disposed on the second surface of the second wall.

9. The battery pack detection system according to claim 8, wherein among each of the M first sensing parts, the first sensing group comprises a plurality of first sensing elements, part of the plurality of first sensing elements each has electrical resistances increasing while the first wall deforms, and another part of the plurality of first sensing elements each has electrical resistances reducing while the first wall deforms; among each of the N second sensing parts, the second sensing group comprises a plurality of second sensing elements, part of the plurality of second sensing elements each has electrical resistances increasing while second wall deforms, and another part of the plurality of second sensing elements each has electrical resistances reducing while the second wall deforms.

10. The battery pack detection system according to claim 9, wherein among each of the M first sensing parts, a projection of the first protrusion onto the first wall is defined as a first projection range, the part of the plurality of first sensing elements is located within the first projection range, the another part of the plurality of first sensing elements is located outside of the first projection range, the electrical resistances of the part of the plurality of first sensing elements increase and the electrical resistances of the another part of the plurality of first sensing elements reduce while the plurality of batteries contact against the first protrusion due to expansion of at least one of the plurality of batteries; among each of the N second sensing parts, a projection of the second protrusion onto the second wall is defined as a second projection range, the part of the plurality of second sensing elements is located within the second projection range, the another part of the plurality of second sensing elements is located outside of the second projection range, the electrical resistances of the part of the plurality of second sensing elements increase and the electrical resistances of the another part of the plurality of second sensing elements reduce when the plurality of batteries contact against the second protrusion due to expansion of at least one of the plurality of batteries.

11. The battery pack detection system according to claim 10, wherein among each of the M first sensing parts, a quantity of the plurality of first sensing elements is four, two of the plurality of first sensing elements are located within the first projection range, another two of the plurality of first sensing elements are located outside of the first projection range, the plurality of first sensing elements are electrically coupled to form a Wheatstone bridge, and the two of the plurality of first sensing elements located within the first projection range do not share a same node among the Wheatstone bridge; among each of the N second sensing parts, a quantity of the plurality of second sensing elements is four, two of the plurality of second sensing elements are located within the second projection range, another two of the plurality of second sensing elements are located outside of the second projection range, the plurality of second sensing elements are electrically coupled to form another Wheatstone bridge, and the two of the plurality of second sensing elements located within the second projection range do not share a same node among the another Wheatstone bridge.

12. The battery pack detection system according to claim 8, wherein each of the two first sensing modules further comprises M first recesses and at least one first protector, the M first recesses respectively expose the second surfaces of the first walls, the first sensing groups are respectively located in the M first recesses, the at least one first protector covers the M first recesses, there is a room located between the at least one first protector and the first sensing groups, and the at least one first protector isolates the first sensing groups from external environment; each of the two second sensing modules further comprises N second recesses and at least one second protector, the M second recesses respectively expose the second surfaces of the second walls, the second sensing groups are respectively located in the N second recesses, the at least one second protector covers the N second recesses, there is another room located between the at least one second protector and the second sensing groups, and the at least one second protector isolates the second sensing groups from external environment.

13. The battery pack detection system according to claim 1, wherein the battery pack detection system further comprises a plurality of connectors, and each of the plurality of connectors connects one of the two first sensing modules and one of the two second sensing modules adjacent to each other and detachable from each other.

14. A detection method for a battery pack module being suitable for a battery pack, wherein the battery pack comprises a plurality of batteries arranged in an M×N array, the plurality of batteries is arranged to have M individual batteries along a first side and N individual batteries along a second side, each of M and N is an integer greater than or equal to 2, the detection method for the battery pack module comprising:
a deformation-acquisition process comprising:
sensing a sum of first expansions of corresponding batteries among the plurality of batteries by M first sensing parts of each of two first sensing modules respectively disposed on the first side and another first side of the battery pack to output M first deformations, wherein the first side and the another first side are located on opposite sides of the battery pack; and
sensing a sum of second expansions of corresponding batteries among the plurality of batteries by N second sensing parts of each of two second sensing modules respectively disposed on the second side and another second side of the battery pack to output N second deformations, wherein the second side and the another second side are located on opposite sides of the battery pack; and
a determination process comprising:
determining whether each of the plurality of batteries is a defective battery according to the M first deformations output by each of the two first sensing modules, M first addresses corresponding to the M first deformations, the N second deformations output by each of the two second sensing modules and N second addresses corresponding to the N second deformations, wherein one of the plurality of batteries is defined as the defective battery when a first expansion of the one of the plurality of batteries is determined as exceeding a first expansion threshold and a second expansion of the one of the plurality of batteries is determined as exceeding a second expansion threshold.

15. The detection method for the battery pack module according to claim 14, wherein the determination process comprises:
a comparison process comprising:
comparing the M first deformations of each of the two first sensing modules with a first safety threshold to obtain M first comparison results; and
comparing the N second deformations of each of the two second sensing modules with a second safety threshold to obtain N second comparison results; and
an address-confirmation process comprising:
determining whether each of the plurality of batteries is the defective battery according to the M first comparison results from corresponding at least one of the two first sensing modules, the M first addresses, the N second comparison results from corresponding at least one of the two second sensing modules and the N second addresses to obtain a defection address of the defective battery located in the battery pack.

16. The detection method for the battery pack module according to claim 15, wherein the comparison process comprises:
dividing each of the M first deformations of each of the two first sensing modules by the first safety threshold to obtain M first quotients and dividing each of the N second deformations of each of the two second sensing modules by the second safety threshold to obtain N second quotients, wherein each of the M first quotients and the N second quotients is an integer greater than or equal to 0; and
setting the M first quotients as the M first comparison results and setting the N second quotients as the N second comparison results.

17. The detection method for the battery pack module according to claim 16, wherein the comparison process comprises:
calculating M averages of the M first deformations of one of the two first sensing modules and the M first deformations of another one of the two first sensing modules so as to set the M averages as M first average deformations;
calculating N averages of the N second deformations of one of the two second sensing modules and the N second deformations of another one of the two second sensing modules so as to set the N average as N second average deformations;
dividing each of the M first average deformations by the first safety threshold to obtain the M first quotients;
dividing each of the N second average deformations by the second safety threshold to obtain the N second quotients; and
setting the M first quotients as the M first comparison results and setting the N second quotients as the N comparison results.

18. The detection method for the battery pack module according to claim 16, wherein before the address-confirmation process, the detection method for the battery pack module further comprises:
establishing a battery address table comprising M×N address cells;
establishing a quotient row and respectively storing the M first quotients into M first quotient cells of the quotient row;
establishing a quotient column and respectively storing the N second quotients into N second quotient cells of the quotient column;
establishing an estimation row comprising M first estimation cells configured to store M first estimation values; and
establishing an estimation column comprising N second estimation cells configured to store N second estimation values.

19. The detection method for the battery pack module according to claim 18, wherein before the address-confirmation process, the detection method for the battery pack module further comprises:
establishing two deformation rows and respectively storing the M first deformations into M row cells of each of the two deformation rows; and
establishing two deformation columns and respectively storing the N second deformations into N column cells of each of the two deformation columns.

20. The detection method for the battery pack module according to claim 19, wherein before the address-confirmation process, the detection method for the battery pack module further comprises:
inputting an integer matrix into the battery table, wherein the integer matrix has M columns and N rows, and each value located at each address of the integer matrix comprises only one integer as being 0 or 1;
adding values in each of the M columns of the integer matrix to obtain M column sums and respectively setting the M column sums as the M first estimation values; and
adding values in each of the N rows of the integer matrix to obtain N row sums and respectively setting the N row sums as the N second estimation values.

21. The detection method for the battery pack module according to claim 20, wherein the address-confirmation process further comprises:
determining whether the M first estimation values are respectively equal to the M first quotients corresponding thereto and determining whether the N second estimation values are respectively equal to the N second quotients corresponding thereto, wherein the integer matrix is defined as a defection matrix when the M first estimation values are respectively equal to the M first quotients corresponding thereto and the N second estimation values are respectively equal to the N second quotients corresponding thereto; and
obtaining the defection address of the defective battery located in the battery pack based on an address located in the defection matrix where an integer as being 1 is stored.

22. The detection method for the battery pack module according to claim 21, wherein inputting the integer matrix into the battery table comprises:
generating a binary series that has M×N values, wherein each of the M×N values is 0 or 1; and
sequentially storing the M×N values into M×N cells and inputting the M×N cells into the battery address table.

23. The detection method for the battery pack module according to claim 22, wherein the address-confirmation process further comprises:
when the integer matrix is not defined as the defection matrix, generating an updated binary series that has M×N updated values, wherein each of the M×N updated values is 0 or 1, and at least one of the updated values of the updated binary series is unequal to at least one of a value of the binary series at a corresponding sequence; and
sequentially storing the M×N updated values of the updated binary series into the M×N cells and inputting the M×N cells into the battery address table to replace the values of the binary series.
